(19) United States
(12) Patent Application Publication
(10) Pub. No.: US 2003/0234967 A1
(43) Pub. Date: Dec. 25, 2003

(54) Interactive document capture and processing software

(76) Inventors: Eric D. Rodriguez, Streamwood, IL (US); Jeffrey S. Schwartz, Chicago, IL (US)

Correspondence Address: David L. Schwartz, Esq., Wallenstein & Wagner, Ltd., 53rd Floor, 311 South Wacker Drive, Chicago, IL, 60606-6630, US

(21) Appl. No.: 10/464,979

(22) Filed: Jun. 19, 2003

Related U.S. Application Data
(60) Provisional application No. 60/390,863, filed on Jun. 21, 2002.

(51) Int. Cl. G06K 15/02; H04N 1/387; G06F 3/12; G06F 15/00

(52) U.S. Cl. 358/518; 715/525

(57) ABSTRACT

A computer-aided system and method for capturing an accurate representation of multiple documents in a computer memory, and for managing a document capture workflow. The method includes enabling a user to view an electronic document image tree representing the documents. The method for managing document capture workflow includes obtaining job information, capturing the documents and processing the document capture job.

### RELATED APPLICATION

This application claims the benefit of U.S. Provisional Patent Application Serial No. 60/390,863, entitled “Interactive Document Capture and Processing Software,” filed Jun. 21, 2002.

### FIELD OF INVENTION

The present invention relates to software for organizing and processing the scanning and/or copying of a large volume of documents.

### BACKGROUND OF THE INVENTION

For many years, businesses such as commercial copy shops have copied large volumes of documents. In a typical scenario in the photocopy industry, the life of a copy project starts by the client calling the copy vendor to have an order picked up. Job instructions are written down at the client's office on a preprinted order form. The client then requests that copy shop make one (or multiple) set of copies of the documents in the identical format (i.e., with identical separators) and order as the original. For example, pages stapled together in the original should be stapled together in the copies.

Once the project is brought into the production facility, the copy center manager will assign a number to the order and, depending on the size of the order, he will break the order up into manageable copy sections. He will then identify every section by writing a label known as the Production Tracking Sheet using the job name, job #, box #, and section number. The machine operator will receive the section to copy and a Production Tracking Sheet to log productivity and billing numbers. The copy shop operator then assigns its employee(s) the task of copying the documents in the boxes. The employees remove each physical page break (e.g., staple, clip, etc.), use standard copy machines to make copies of the documents and then assemble the copied documents in the same format and order as the originals.

Photocopy centers generally perform a quality control check on copies produced. Usually, a separate employee will manually compare the copied and original documents to minimize errors. They will page check each copy against the original by flipping one page at a time and viewing both the fronts and backs. If a user needs to go directly to a folder towards the middle or end of a box, they can simply grab the file from the stack of originals and then grab the corresponding file from the stack of copies.

Thereafter, labels with sequential numbers are applied to the copied pages. During the manual page numbering process, the photocopy facilities print a numeric sequence of numbers on rolls of small label stickers, 1 ½″×¾″, then a production employee applies the label stickers using a machine which automatically advances the rows of labels as they are pulled from the sheet. Labels are applied, one at a time, to the documents, normally in the header or footer region. This process obviously is very labor intensive. One standard box of 3,000 documents can take roughly two hours to label. Additional copy sets are optionally made using the numbered copied documents.

After the project is copied and verified for quality control it is reassembled and then invoiced. Finally, the original and copied boxes are reassembled and delivered to the client. Most of the tasks during the project lifecycle are either fractionally automated or handled manually, and thus the current state of technology requires a labor intensive approach for these services.

Accounting procedures for order management, billing, collections, time clock management and order processing are all manual or fragmented automated procedures. Job orders are entered manually into a book of orders, written on a job board, sectioned off manually, processed and then the meter readings are tallied up. Some facilities use generic spreadsheets or equivalent software to calculate invoices.

Traditional scanning software requires bar coded sheets to log type and placement of page breaks. This means that the user must place a particular bar coded sheet before each document break (i.e., paper clip). This approach has difficulty capturing multiple levels of document breaks. Bar coded sheets that identify the beginning of a document require document “preparation” and is a labor intensive task. Bar code users pay to first produce the sheets and then they pay the software provider when the sheets are scanned. A need exists for an efficient method for managing the document capture workflow using a single computer application. It would be cost effective to manage the job information, division of jobs between employees, and other functions in a single computer application.

A need exists for an easy and accurate system and method for obtaining important information about documents in a computer memory. Information including the document image and the order and location of the various document separators would be very helpful in efficiently making copies of documents. It is not unusual for a client to request multiple copy sets at different times. Without such information stored in a convenient format in a computer, the entire copying process needs to be repeated each time (including removing all the physical page breaks).

Finally, a need also exists for a method to view an electronic version of multiple documents using a computer interface. This will reduce manual hours needed and increase efficiency in both quality control and arranging for multiple sets of copies of the same job.

### SUMMARY OF THE INVENTION

The present invention comprises an efficient method for managing the document capture workflow using a single computer application.

The present invention is primarily designed for photocopy centers which are comprised of vendors that operate 24 hours per day, seven days per week, although the features of the present invention may be utilized by anyone. Photocopy centers may include in-house copy centers, off-site copy centers and retail copy services.

The present invention is intended to automate and integrate the stages of the photocopy production process. The invention provides an efficient means of entering customer orders into the system, capture document images, print additional sets on demand, reconstruct all physical page breaks in the additional copy sets without having the originals or a hard copy to guide the machine operators through the process, create billing summaries and provide a signed invoice search and retrieval application. The application will also provide detailed and accurate reporting for production productivity, customer usage and employee time cards.

In one aspect, the present invention includes a system for obtaining information about documents in a computer memory using a touch-screen monitor. The touch-screen monitor includes easy to use buttons that can capture document images, various information about physical page break separators and other important document information.

Finally, in a further aspect, the present invention enables a user to view an electronic version of multiple documents using a computer interface in the form of a document image tree. The document tree includes the important information about multiple pages and documents, as well as contains an image of the pages.

For purposes of the present invention, the phrase “physical page break” (PPB) shall mean anything that connects or otherwise affiliates multiple pages that belong or are intended to be together in the original documents. PPB includes items such as a paperclip, rubber band, binder clip, file folder, book binding, file pocket, index tab, staple and other logical document breaks known to those skilled in the art.

### BRIEF DESCRIPTION OF THE DRAWINGS

FIGS. 1-8 show flow diagrams for the present invention.

FIGS. 9-16 show touch-screen displays for a preferred embodiment of the present invention.

FIG. 17 shows a touch-screen display for an alternative embodiment of the present invention.

### DETAILED DESCRIPTION

The present invention consists of interactive document capture and processing software (IDCP) 1000, and is comprised of three software application components. The software is directed to any user and may be particularly useful and desirable for photocopy users and implementation into any xerographic duplicating center. The three components are a document capture component 10, a quality control component 1004, and a workflow management component 1006. It is understood that the software may be implemented in hardware or any computer readable medium.

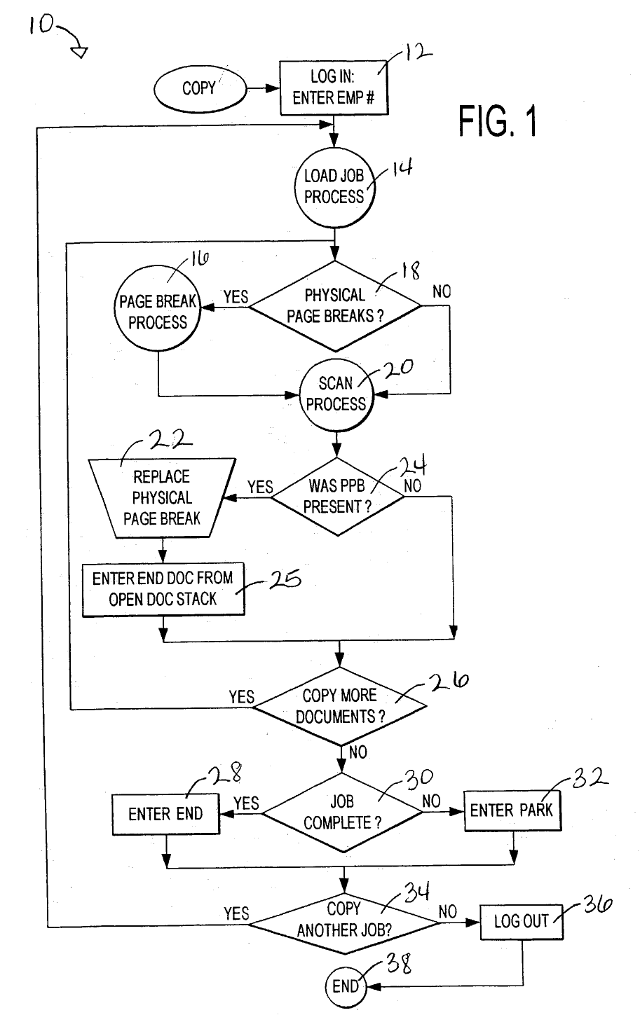

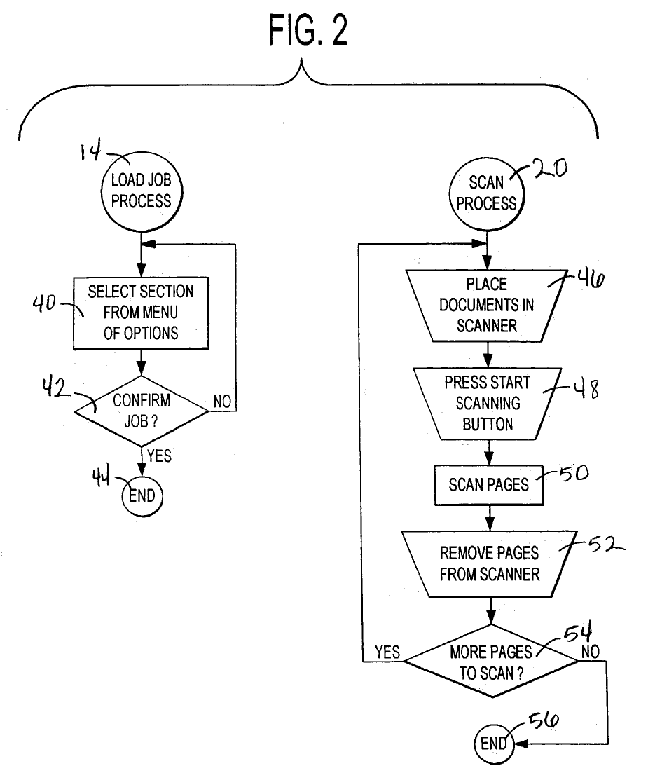

FIGS. 1-8 show the general logic of computer capturing and processing software. I-CAP is flexible enough to accommodate the PPB cues through three mediums; touch-screen monitor, voice recognition, or by inserting page break sheets. Turning first to FIG. 1, a user logs into the system at node 12. This may include an employee number, name or other identifying information. Next, at node 14, the user loads the job process, as described in more detail below and illustrated in FIG. 2.

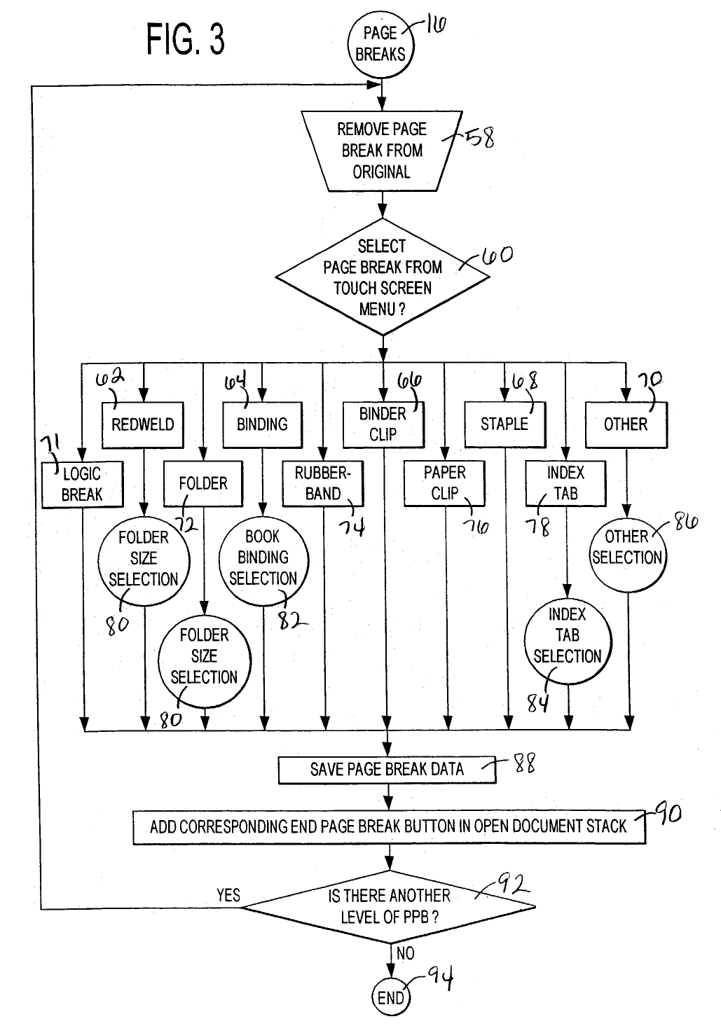

The capture process is next. The user starts at a particular page in the original documents, and continues forward page by page. At each page, the user decides at node 18 if any PPB's are present. If a PPB is present, the user proceeds to page break process node 16 which is described in more detail below and illustrated in FIG. 3. If no PPB is present after node 16 has been performed, the user performs scan process 20. Scan process 20 is also described in further detail below and illustrated in FIG. 2. The user then checks if the PPB pages are finished at node 24. By this, applicant is referring to a set of pages within a particular PPB. If a PPB was present and the pages associated with that PPB have all been scanned, the PPB is physically replaced on the original document at node 22 and the user selects the PPB end button at node 25. Thereafter, the user continues copying more documents at node 26 and repeats the process. When the user is done, at node 30 the user enters whether the entire job is complete. The job may either be parked if the job is not done (at node 32) or ended at node 28. The user thereafter may work on a totally separate job at node 34 in which the entire job process is repeated. Finally, the user logs out at node 36 and ends work at node 38.

Turning now to FIG. 2, the load job process node 14 and scan process node 20 are illustrated with additional detail. When loading a new job, at node 40, a user is able to select from the various jobs and work assigned to him or her. The user selects which job to work on at node 40 and confirms it at node 42, ending the load job process at node 44. Scan process node 20 is how the pages are scanned into computer memory. It is understood that electronic images or copies of the documents may be obtained by other methods as well, such as uploading through the internet, electronic files on a CD, etc. First, a document is placed on the scanner at node 46. The scanner start button is pressed at 48 and pages are scanned at node 50. Pages are then removed from the scanner at node 52 and the user continues scanning pages at 54 until end 56. In scan process 20, multiple pages are scanned, provided there are no PPB's between the pages.

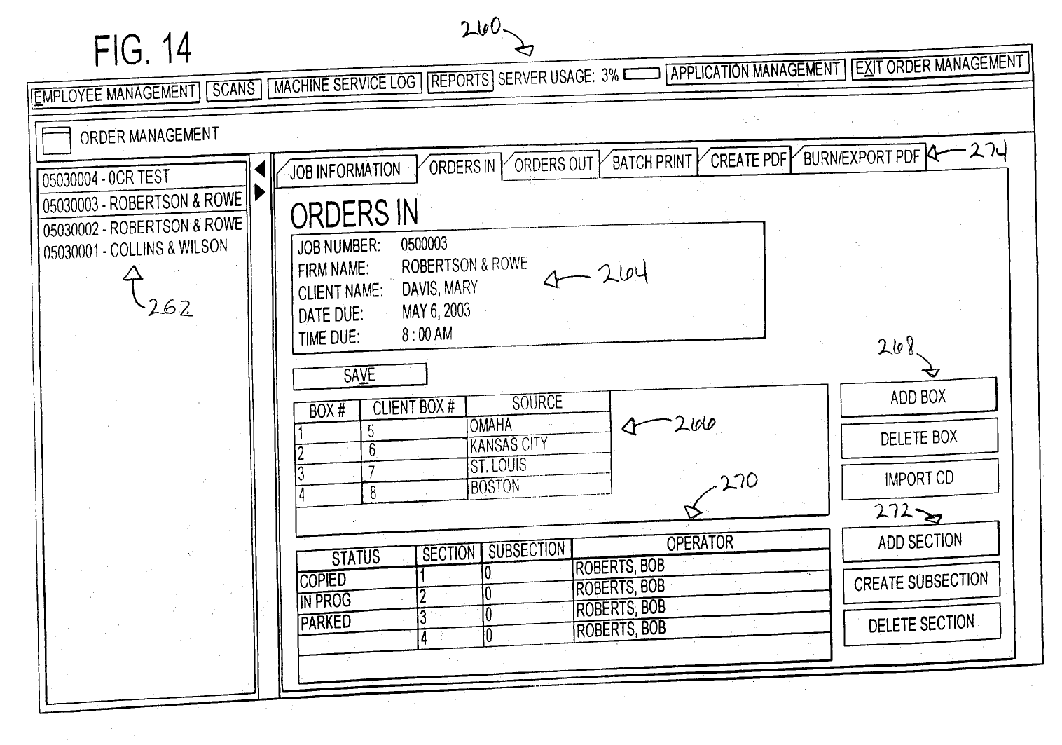

FIG. 14 illustrates another screen capture 260 from the present invention. Screen 260 permits the manager to view important information about a job. For example, all presently active jobs are displayed by number and client name at area 262. Tab bar 274 summarizes all of the functions the manager can perform. When a user selects a particular job at area 262, the associated job information is displayed at area 264. Information on the boxes is displayed and may be edited at area 266. Boxes may be added, deleted or CDs may be imported at area 268. The progress on the job is summarized in area 270 with the ability to modify that at area 272.

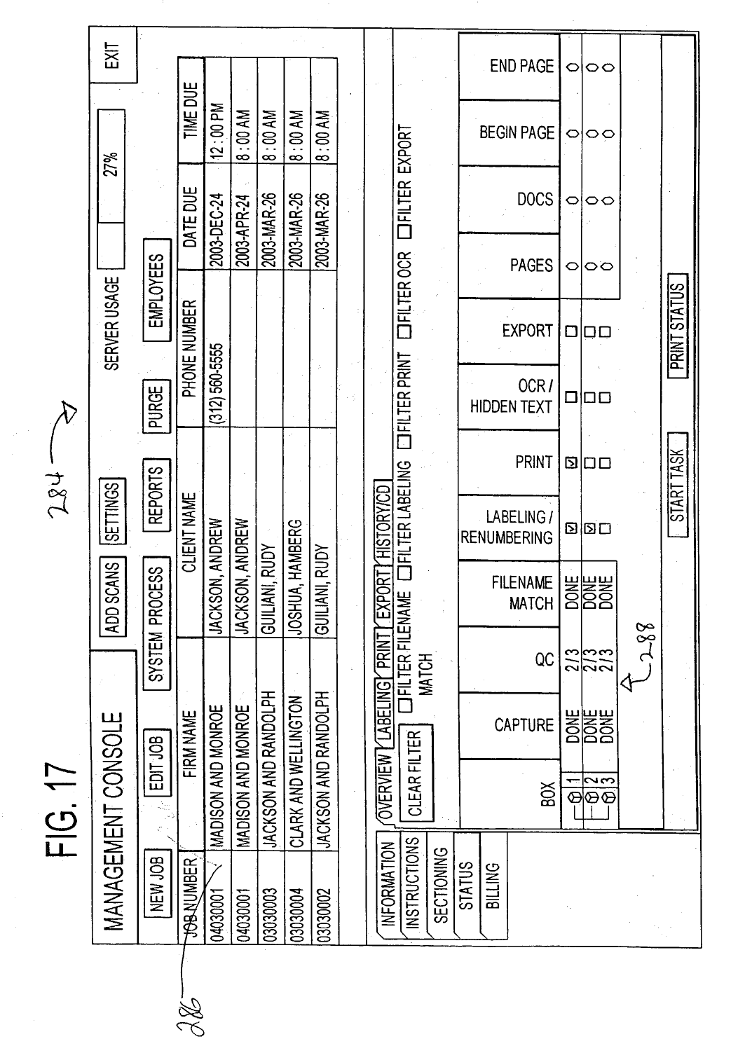

FIG. 17 illustrates screen capture 284 which is an alternative embodiment of the present invention. Job information 286 is displayed with further detail. Box and job status information 288 is also provided in an easy to read format on a single screen.

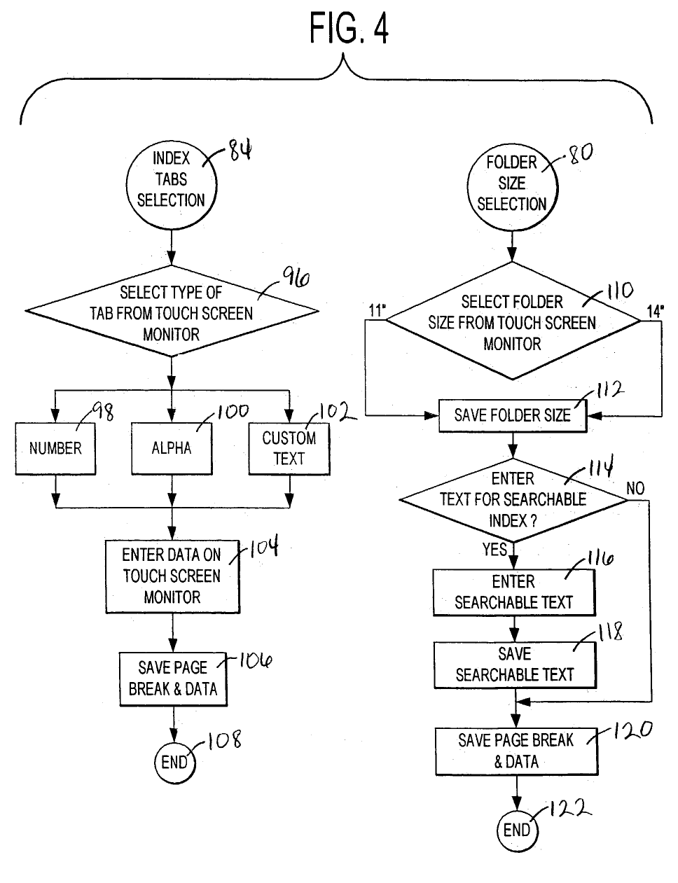

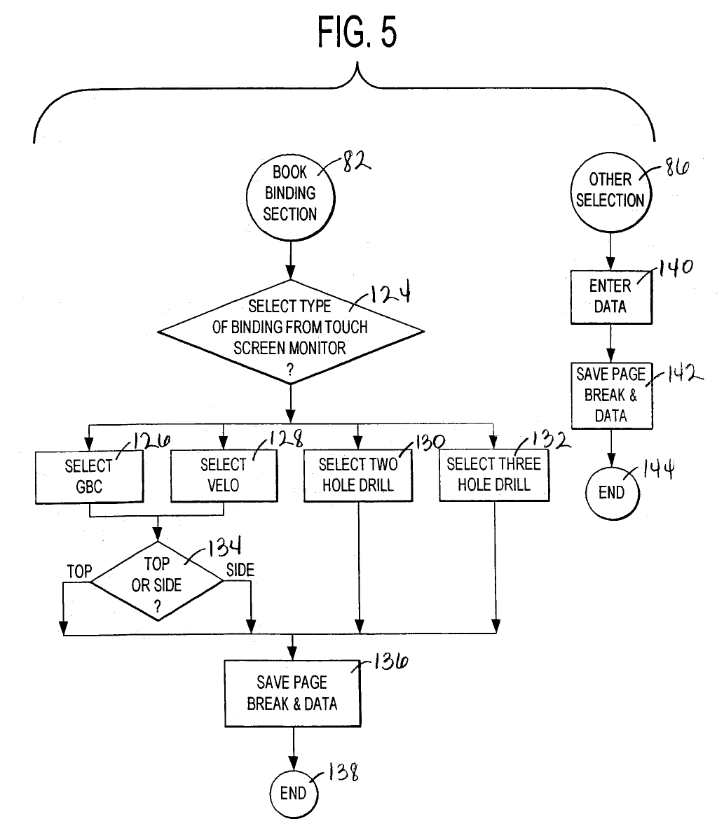

FIG. 3 illustrates page breaks node 16. First, the user removes the physical page break (i.e., the staple) from the original document at node 58. At node 60, the user selects which type of physical page break was removed. This is preferably done through a touch-screen computer monitor; however, it is understood that this can be accomplished by voice recognition or even use of a computer keyboard. The main physical page breaks are redweld 62, binding 64, binder clip 66, staple 68, other 70, logical break 71, folder 72, rubber band 74, paper clip 76 and index tab 78. If a user selects either redweld 62 or folder 72, folder size selection node 80 is utilized. This is illustrated in FIG. 4 and described below. Index tab 78 utilizes index tab selection 84 which is also illustrated in FIG. 4. Binder 64 and other 70 utilizes book binding selection 82 and other selection 86, respectively, which are illustrated in FIG. 5 and also described below. The page break data is then saved at node 88. The system remembers which PPB's are open by adding a corresponding end page break button in the open document stack at node 90. At node 92, the user enters whether there are multiple levels of PPB's. By this, applicant refers to a document which contains more than one PPB's. For example, six pages may be paper clipped together, the first three of the six pages stapled to themselves and the second three of six pages stapled to themselves. The present invention is able to accurately keep track of all PPB's information, even intertwined PPB's. Finally, page breaks node 16 ends at node 94.

FIG. 4 illustrates both index tabs selection 84 and folder size selection 80. Index tabs selection 84 allows the user to select the type of index tab at node 96. This includes various types including for example a number 98, alphabetical character 100 or customized text 102. The tab information is entered, preferably on the touch-screen monitor at node 104 and the relevant information is stored and saved in computer memory (or otherwise) at node 106. Finally, index tabs selection 84 ends at node 108.

Folder size selection 80 permits the user to select the folder size, usually either eleven inches or fourteen inches at node 110. This information is saved at node 112. The user optionally may input text (numbers, alphabetical characters, or entirely customized text) which is searchable at nodes 114 and 116. This information is saved at node 118, the PPB information saved at node 120 and the selection ends at end 122.

FIG. 5 illustrates book binding selection 82 and other selection 86. Book binding selection 82 permits the user to select the type of binding at node 124. The type of binding includes, for example, spiral bound 126, velo-bound 128, two hole drill binding 130 and three hole drill binding 132. The spiral bound and velo-bound type may be done at either the top or the side at node 134. The PPB and related data are stored at 136 and this selection ends at 138. Finally, other selection 86 includes entering data (customized) at node 140, saving PPB and relevant information at 142 and ending at 144.

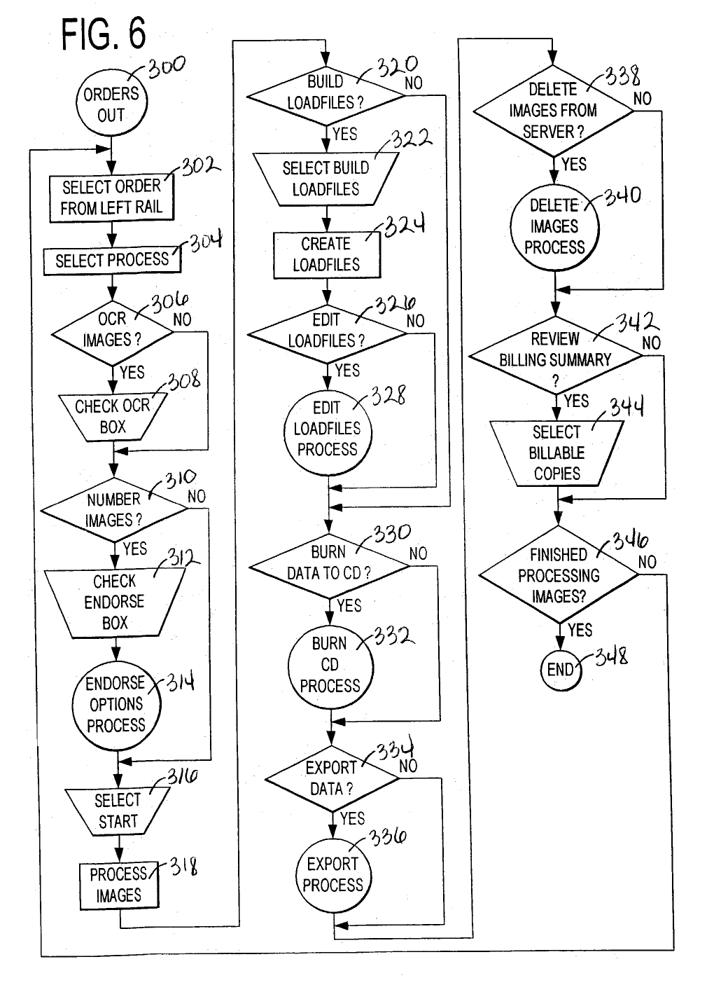

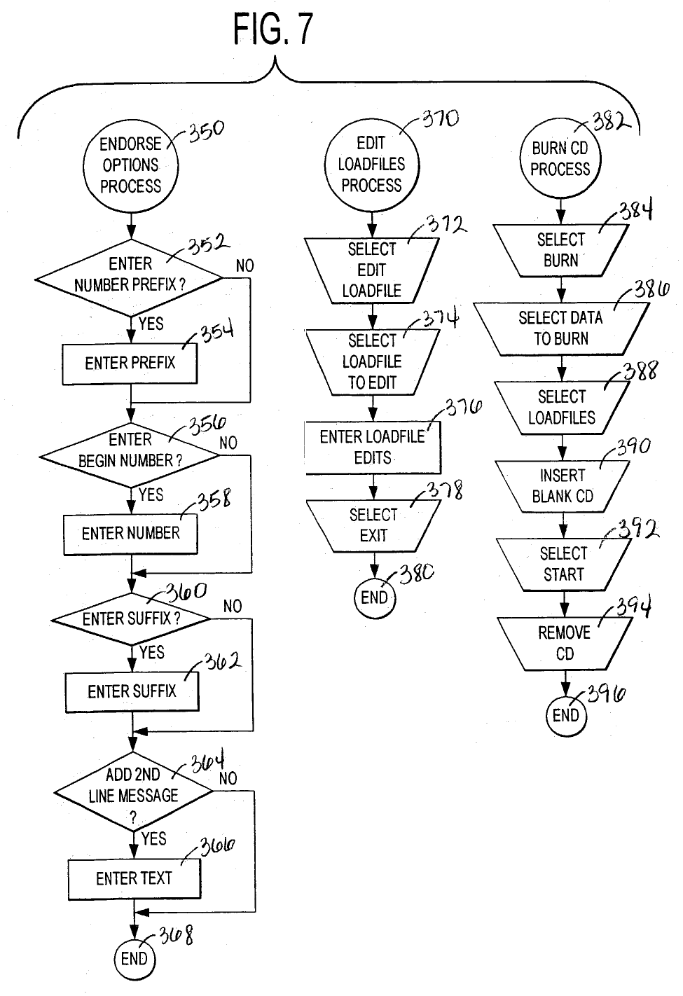

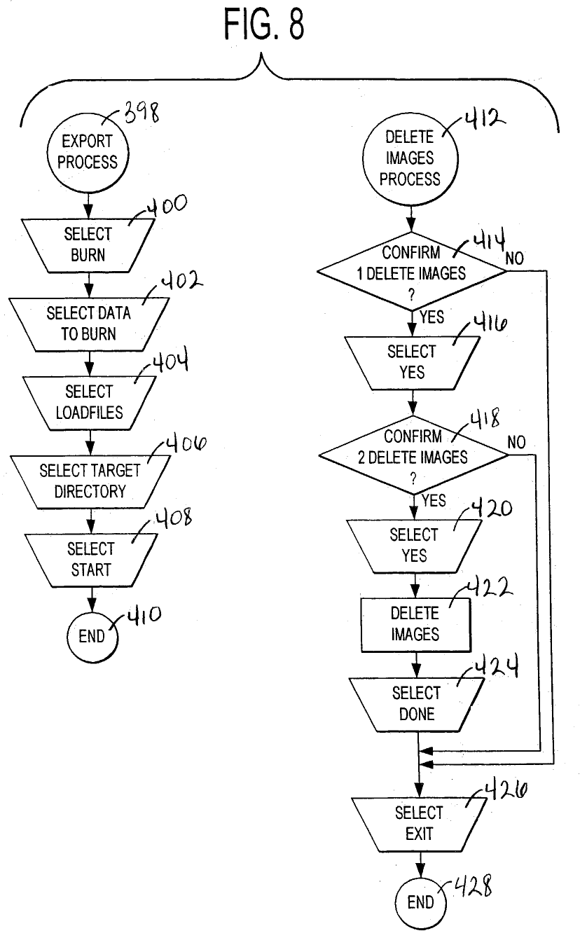

FIG. 6 illustrates the method for processing jobs after capture, known as orders out 300. A user selects a job, preferably from the rail on the left side of the screen at node 302. The user selects from the various preprocess 304 options such as performing optical character recognition on the documents (nodes 306 and 308) and numbering the pages on the documents (nodes 310, 312 and 314). Numbering the pages, otherwise known as endorsing, is described in more detail below and illustrated in FIG. 7. Once the preprocessing items, if any, have been selected, the processing is started at nodes 316 and 318. Loadfiles may be created and edited if desired at nodes 320, 322, 324, 326 and 328. The edit loadfiles process is described below and shown in FIG. 7. The user may optionally burn the data on a CD at nodes 330 and 332 (see also FIG. 7) or export the data to a network or anywhere else at nodes 334 and 336 (see also FIG. 8). For space or other reasons, the data, especially the images, may be deleted from the server at nodes 338 and 340 (see also FIG. 8). Finally, the billing for the processed job may be reviewed at node 342 and billable copies may be selected at node 344. When a user is finished processing at node 346, orders out 300 ends at node 348.

FIG. 7 illustrates the endorse options process 350, edit loadfiles process 370 and burn CD process 382. For the endorse options process 350, a user may select a prefix that should appear on the documents before the numbering at nodes 352 and 354. Typically, these are several letters which identify the source of the documents. The user can select the first number at which to start numbering at nodes 356 and 358. Optionally, a user can select a suffix (nodes 360 and 362) and/or a second line of text (nodes 364 and 366) to be endorsed on the documents. For the edit loadfiles process 370, the user selects which loadfile to edit (nodes 372 and 374), edits the loadfiles and then exits. For the burn CD process 382, the user selects the burn option 384, selects which data to burn at node 386, selects the loadfiles at node 388, inserts a CD at node 390 and starts the process.

FIG. 8 illustrates the export process 398 and delete images process 412. Export process 398 involves selecting the export option (node 400), selecting which data to burn (node 402), selecting the loadfiles (node 404), specifying a target directory (node 406) which can be on the same computer, another networked computer or any other directory or storage device. Delete images process 412 permits deletions of images (node 422). To prevent inadvertent deletions, the preferred embodiment requires two separate confirmations (nodes 414, 416, 418 and 420) before deletions.

One aspect of the present invention is called I-CAP 102, an interactive document scanning software application that features a touch-screen monitor and open document stacking (OD Stack) technology. OD Stack technology means that the software, by means of a data structure for storing items which are to be accessed in last-in first-out order, keeps track of PPBs. The software also keeps track of each PPB's parent, siblings and children. For example, take a job including a folder containing (i) eight pages stapled together; (ii) three pages paper clipped together; and (iii) a subfolder with 5 pages stapled within it. First, folder is pushed to the OS Stack. Then, staple is push onto the OS Stack, now containing both folder and staple. Then, the staple is popped from the OS Stack, leaving the folder alone on the OS Stack. Then the paper clip is pushed onto the stack, now containing both folder and paper clip. Then the paper clip is popped from the OS Stack, leaving the folder alone again. Thereafter, the subfolder is pushed onto the OS Stack (containing now folder and subfolder), and then the staple is pushed onto the OS Stack (containing now the folder, subfolder and staple). Finally, the staple, then subfolder, then folder and popped from the OS Stack, leaving the stack empty. The software maintains a record of each PPB, who the PPBs' parents and children are (from the OS Stack), who the PPBs' siblings are (historic from OS Stack) and how the pages are organized.

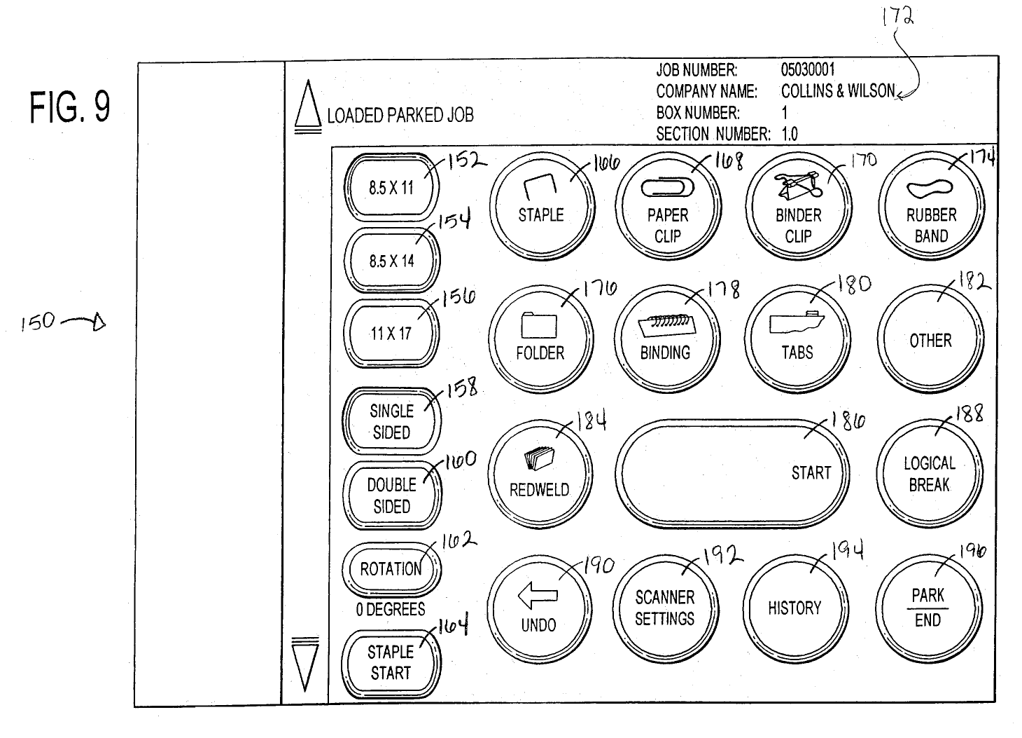

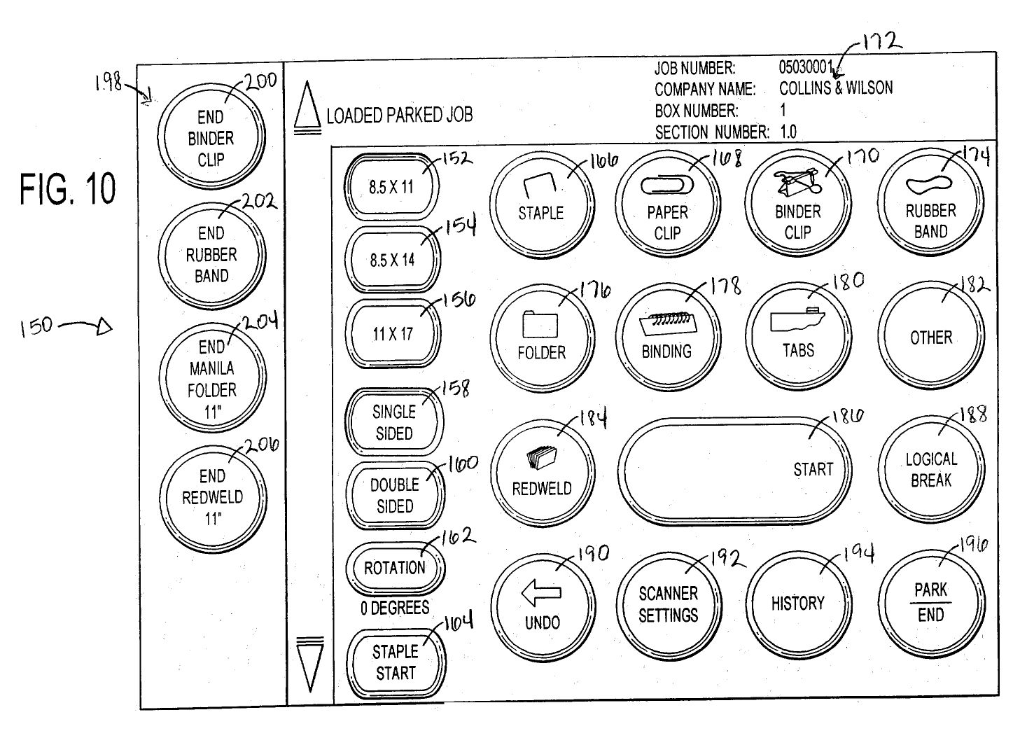

As illustrated in FIGS. 9 and 10, the interactive software displays a menu of buttons on a touch-screen monitor at the copying or scanning station. Job information such as job number, company name, box number, etc. are displayed in area 172. Start button 186 initiates the scanning of a page of a document. Single sided button 158 and double sided button 160 are used to provide information as to the original document to be scanned to communicate with the scanner. The present invention maintains and affiliates the single/double sided information with the scanned pages for use in creating the copy. Scanner setting button 192 allows a user to make changes to the scanner such as brightness, contrast and backside drop. The size of the page to be scanned can be set as 8 ½″×11″ (button 152), 8 ½″×14″ (button 154) or 11″×17″ (button 156). Alternatively, the scanner can be set to landscape or portrait. The image may be rotated (landscape/portrait) by 180 degrees (or any other number of degrees) at button 162, which typically used if the originals are of poor quality on one portion of the page.

During the scanning copying process, physical page breaks (PPB) are removed from the paper in order to place those documents in the machines. When a PPB is removed, the user will touch the corresponding PPB button from the menu of buttons to identify the beginning of a document. For example, a user may touch staple button 166, paper clip button 168, binder clip button 170, rubber band button 174, folder button 176, binding button 178, tabs button 180, redweld button 184, the logical break button 188 or the miscellaneous/other PPB button 182. An icon of the PPB is also displayed within the button for ease of use. Every PPB is considered a document level and each open level is displayed on rail 198 as a stack of “End Document” buttons down the left side of the application screen (OD Stack). Once the last page of a document is scanned, the user will touch the corresponding end button from the OD Stack to identify the end of the document. There is no limit to the number of page breaks opened at one time. For example: a file folder with four levels of subdocuments would be logged, for example, by touching the file folder button 176, then the rubber band button 174, the binder clip button 170, the paper clip button 168 and then the staple button 166. At the end of the stapled document, the user will touch the end staple button 200. If there is another stapled group, the user will touch the staple button 166 from the menu of PPB's to identify a new staple group. The user can also hit the park/end button 196 to cease work on a job at any time. The preferred embodiment of the present invention includes start/staple button 164 which performs the functions of all of staple button 166, start button 186 and end staple button in a single button. It is understood that, similar to the start/staple button 164, any PPB can be combined with the scan button into a single button. All other PPB's will remain open until the user finishes scanning the last page of each PPB level. Open PPB's (the OS Stack) are displayed on rail 198, which is illustrated as vertical on the left side of the computer monitor. For example, in FIG. 10, the document being scanned currently has an open rubber band 202, manila folder 204 and redweld 206. Undo button 190 can be used to undo the last button touched by the operator. It should be understood that instead of a touch-screen monitor, voice recognition software or devices, keyboard, mice, foot pedals, headsets or other devices may be used to register the PPB's.

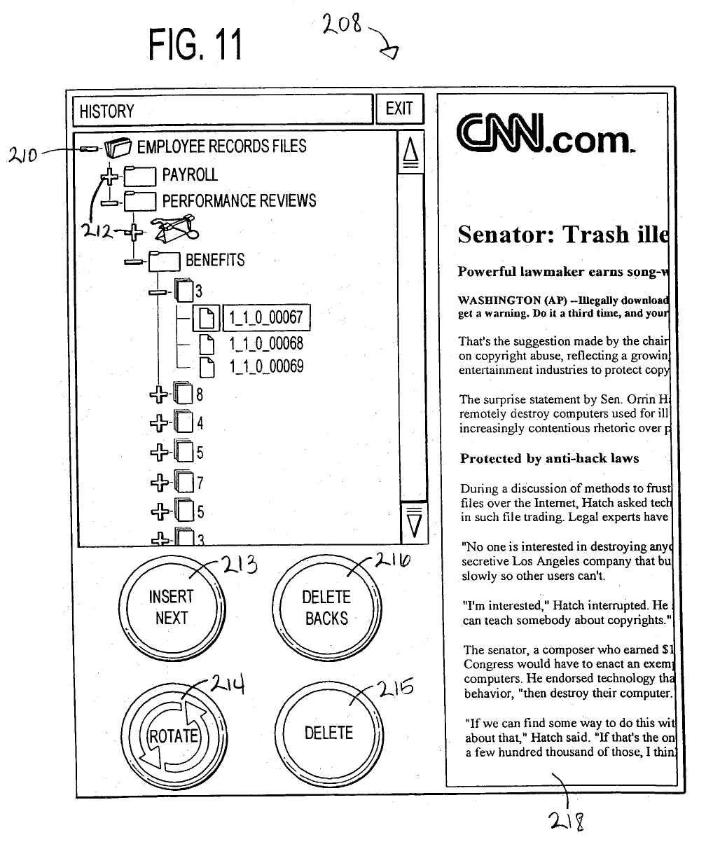

This process of capturing PPB's will create a hierarchy of document levels and can be viewed using the history button 194 or in the QC application. The hierarchy of documents built during the scanning and/or copying process is referred to as the Document Image Tree (DIT) and is displayed as illustrated in FIG. 11. If a box contains three expandable file folders, the application will show an expandable folder icon for each one. When a user wants to view the contents of the folder they can touch the folder icon and the sublevels of documents will be displayed. By touching any particular page, the image of the page appears on the monitor. The history of a document is updated simultaneously with the input of the page image and the PPB information.

FIG. 11 illustrates a screen capture from the electronic-document tree in the history view 208. The different PPBs are displayed with icons, and the number of pages within each PPB are listed. The “+” symbol 212 indicates that all sub PPBs and pages are closed (and thus not displayed) within the tree. This is useful to permit more information to be visible on a single screen. The “−” symbol 210 indicates that the PPB is open and sub PPBs/pages are displayed. When touching or otherwise indicating a specific page on the electronic document tree, image 218 of the associated page is displayed. It should be understood that image 218 may be displayed as the complete image of the document, a zoomed partial image or a cutoff image. Button 214 permits an image to be rotated, if for example, it was copied in the wrong orientation. Button 216 permits conversion from duplex to simplex. Button 215 deletes a page or PPB and button 213 permits insertion of additional pages or PPBs.

I-CAP's primary function is to identify and store the location of each and every PPB, by the touch of a button, while converting paper documents into digital images. This approach is facilitated by use of a touch-screen monitor. In the preferred embodiment, I-CAP is comprised of finger-sized electronic buttons which display icons of corresponding page breaks. When a machine operator removes a paperclip from a document, they touch the button with the paperclip icon. The application will then display an open paperclip button in the Open Document Stack (OD Stack).

OD Stack Technology was created to give machine operators a view of open PPB levels and to provide a simplified method to identify the end of a document. Bar coded sheets are not practical for identifying the end of documents. There are two methods for bar coded sheets to mark the end of documents; by inserting additional bar coded sheets or by assuming the next begin document bar coded sheet is the end of the previous document. End users of the images will not have to have any detail on the origins or levels of documents unless they incur additional document preparation charges. With the OD Stack Technology, users can view every open level of document and by touching a button they can simply and easily end a document by the touch of a button. The OD Stack Technology does not require additional labor, additional fees to either vendors or end users, and does not limit the number of document levels that can be captured.

The combination of a touch-screen monitor and OD Stack technology provide easy to use and operate software. In the preferred embodiment, this application does not use a keyboard or a mouse for any function or task, although it is understood that such device may be utilized if desired. The user interface displays buttons with icons of commonly used PPB's.

Another aspect of the present invention is called I-QC 1004, a supporting application to the I-CAP software. The process is based on surfing through the hierarchy of images with a touch-screen monitor or voice recognition commands. The user will check every image against the originals for industry quality standards. The DIT is used to go directly to any particular document or page, move documents in the hierarchy, delete documents, or insert new documents all by the touch of an electronic button on the monitor. The application will let the user surf from page to page or from document to document while viewing the desired image at the same time.

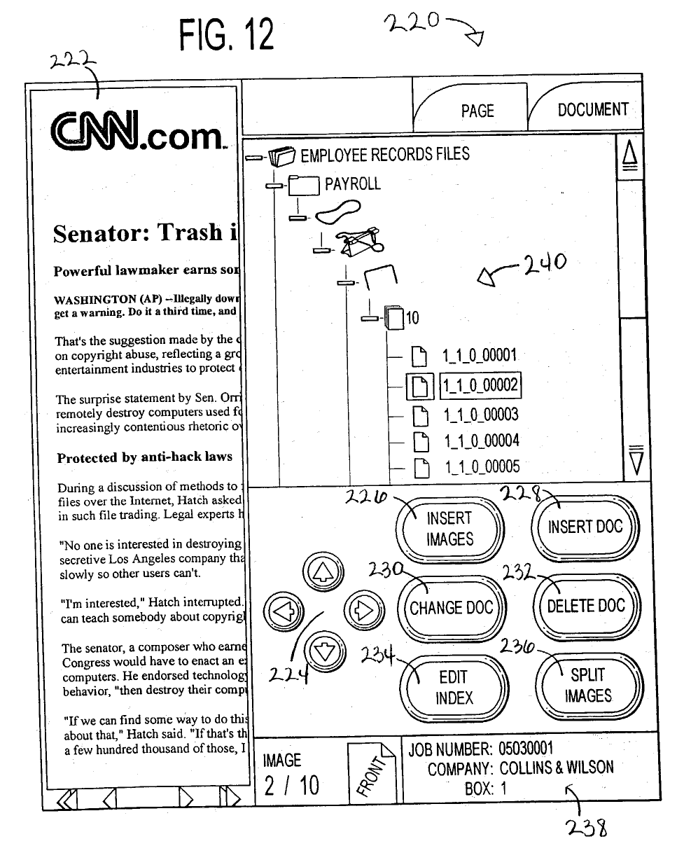

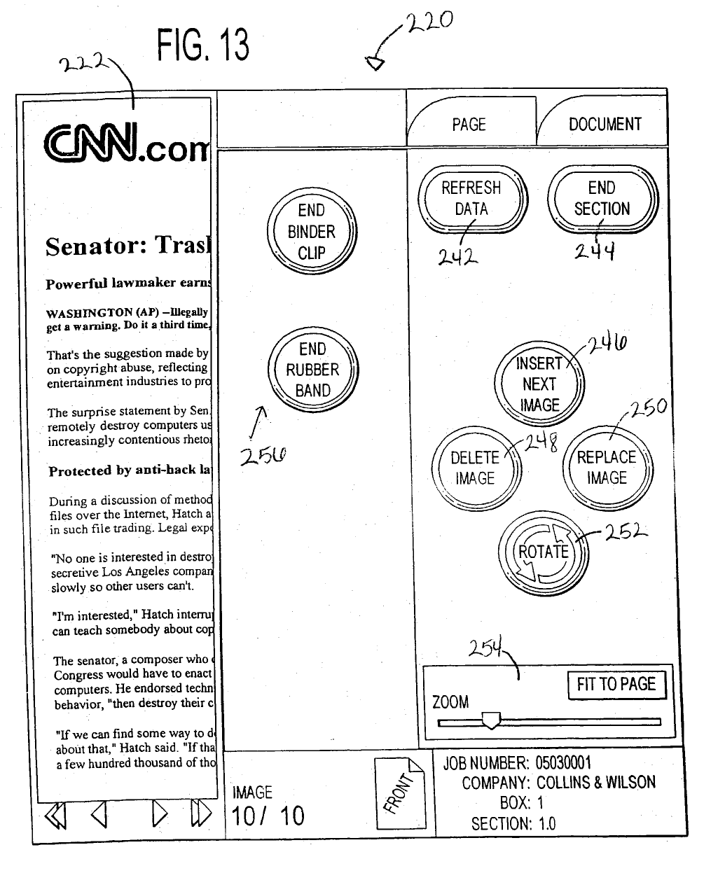

FIGS. 12 and 13 illustrate a screen capture from the electronic document tree in the QC view 220. FIG. 12 is the document-level screen capture and FIG. 13 is the page-level screen capture. Electronic tree 240 is similar to that described above in FIG. 11. Buttons 224 allow a user to quickly move along electronic document tree 240. Using buttons 220 and 228, a user can insert images and documents, respectively, that may have been missed in the initial copying. Using buttons 230 and 232, a user can change any document or delete any document respectively. The index to any PPB can be changed at button 234 and pages may be split at button 236. Splitting a page allows a user to separate pages that were fed into the scanner together. The application also displays the image 222 of the page currently being viewed, which image may be of the entire document or a portion thereof. In document view at FIG. 13, electronic tree is replaced with the particular document being viewed. Rail 256 (similar to rail 198) indicate the PPB's in that particular document, although in the preferred embodiment, the PPBs cannot be changed in the page-level QC view. The user can refresh data at button 242 to reflect changes being made. The user may scroll through the images of the pages with button 246, delete an image with button 248, replace an image with a different image at button 250 and rotate an image with button 252. Button 244 ends a QC session. Button 254 allows a user to zoom in on the image of a page so as to more easily view details from that page.

IQC is designed to correspond with the I-CAP application by utilizing a touch-screen monitor, in one embodiment. Multiple layers of document organization typically found in paper files are recreated electronically. Users can search, sort, retrieve and view files in the same manner as opening a box of paper documents.

The graphical icons display boxes, redwelds (expandable, red rope accordion folders), manila folders, book binding and documents grouped by rubber-bands, binder clips, paperclips, or staples. As illustrated in FIGS. 11-13, the DIT gives users an electronic view of a box of documents similar to physically opening a box of paper documents. They may either surf through by the smallest document level or they may go directly to a box, folder, document or page by simply touching the desired icons in the overhead view. The DIT may utilize graphics familiar to those that handle voluminous amounts of paper files. Like I-CAP, there is no need for a keyboard or mouse to operate this application.

Since traditional imaging software typically captures only the smallest document level, users do not get the organizational benefit that hard files or the IDCP offer. Users have to hunt for the first page of the file they are looking for. The present invention gives users the ability to go directly to the desired folder. They do not need to surf through the pages at the document level.

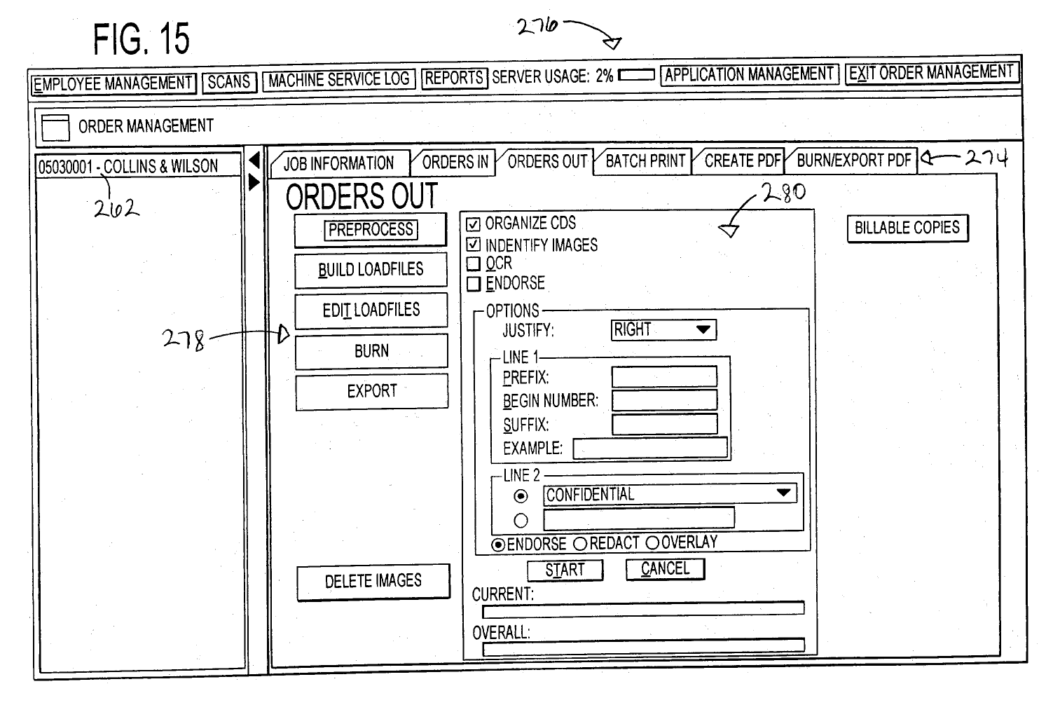

FIG. 15 illustrates yet another screen capture 276 of the present invention relating to the process of orders out 300. The user selects a job at area 262. Tab bar 274 lists the various processing options available to the user for all jobs. Area 278 illustrates that the job may be preprocessed, built into loadfiles, edited as loadfiles, burned or exported. Area 280 shows the various options under preprocessing.

IPA is the print application which also implements, in the preferred embodiment, a touch-screen monitor. Photocopy operational systems have relied on having the stack of documents being copied present in order to recreate PPB's in the copy sets. Copy machines, at most, can only generate staples and no other PPB's. Traditional scanning software, using bar coded sheets, could capture PPB information but reassembling documents require printing projects and along the way printing the bar coded sheets to signify where PPB's should be inserted. This method requires a person to sit and look for bar coded sheets after the document stack has been printed out.

Additionally, a complete set of documents may be assembled anywhere in the world. By use of the internet, a disk or other medium containing the information from the scanned job, a user can print and assemble a set of documents. This is possible regardless of whether the original documents or another physical copy of the documents are present where the new set is desired.

A third aspect of the present invention is called ILM 1006, the Interactive Live Information Management System. This is a management console that every copy/scanning project uses to be introduced into the software. This application will manage all the projects deadlines, assign copy sections, track progress, track productivity and display live updates of metrics for time clock, productivity, revenue, and labor expense. The management console will also store, search and retrieve signed invoices for collection personnel and electronically maintain the industries machine service log for the management personnel.

An aspect of workflow management 1008 is an image printing application that will queue the machine operator when a PPB needs to be inserted into the printed documents. The present invention sends print jobs to a digital copier by the lowest level page break (staples or loose pages). When a PPB needs to be inserted the software application stops the copy machine and will alert the user to insert the corresponding page break. The user will insert the appropriate page break and then press a continue button to print the next batch of page breaks. At the end of the print job, the operator will have a copy set of documents that are assembled with physical page breaks exactly like the originals.

Alternatively, IPA can accurately queue the machine operator to insert every level of PPB. The photocopy machine will print the copy sets and automatically insert staples. Every additional level of PPB will momentarily stop the machine and then display a message of which PPB to insert and where it begins and ends. Additionally, IPA will display project instructions on the application interface.

ILM combines order management, productivity reporting, employee time clock management and document post production processing which are directly linked to the machines that are generating revenues. ILM attempts to automate every reporting, labeling, data entry, and tracking task. When picking up orders, vendors can have handheld devices to take instructions. Upon arrival at the copy facility, job instructions may be electronically beamed into the order management system. Various information about the job such as client name, delivery address, due dates and times, number of boxes, estimated number of copies and other special handling instructions are entered into the software. Managers could then electronically section off jobs and automatically print section identification sheet instead of writing them. Since order processed on digital scanners, no production tracking sheets need to be printed or filled out. Data for copy orders is captured automatically and invoices can be generated without manual calculations or accessing a separate computer applications. After orders are delivered and invoices are signed, vendors may access signed invoices during collection efforts.

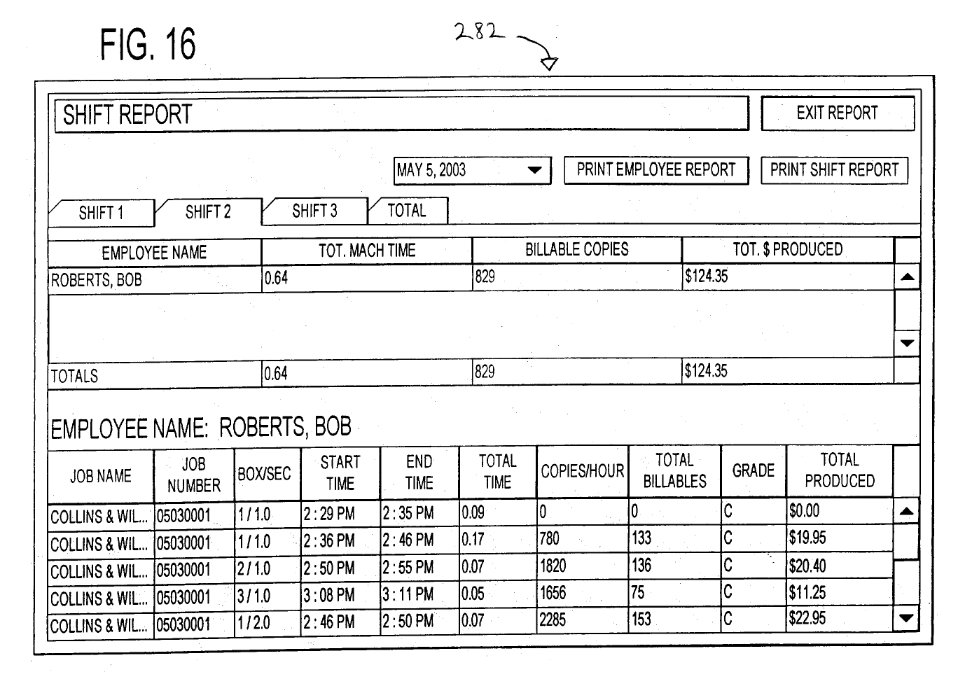

Generating reports from data that is continually collected from the scanning and copy machines will provide up to the minute productivity reporting and client usage reports. Implementing employee time clock will complete all the metrics needed to calculate reports on every measurable indicator of business performance such as employee productivity, revenue generated and rate of income, and labor percentage with respect to revenue generated. FIG. 16 illustrates an example of report 282 of the present invention.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims. Also, in the following claims, those elements which do not include the words “means for” are intended not to be interpreted under 35 U.S.C. §112¶6.

1. A computer-aided method to enable a user to view an electronic document tree representing more than one physical multi-page document comprising:
a) providing a user interface;
b) obtaining an image of each page of each physical document;
c) inputting, through the user interface, marker information identifying the beginning and ending page locations of one or more sub-documents and the type of separator at the beginning and ending page locations; and
d) generating an electronic document image tree of the physical document wherein the document tree links the marker information with the pages and images of the physical document.

2. The method of claim 1 wherein the user interface is a touch-screen computer monitor.

3. The method of claim 1 wherein the user interface comprises voice recognition.

4. The method of claim 1 wherein the type of separator of the marker information includes staples.

5. The method of claim 1 wherein the type of separator is selected from the group consisting of paperclip, rubber band, binder clip, file folder, book binding, file pocket, file pocket, index tab, staple and logical document break.

6. The method of claim 1 wherein the electronic document image tree is capable of being viewed with marker information in an opened position and a closed position.

7. The method of claim 1 wherein the marker information includes at least two types of separators.

8. The method of claim 1 wherein a page may be linked with multiple types of marker information.

9. The method of claim 1 wherein the electronic document image tree is generated substantially simultaneously with the input of marker information and obtainment of images.

10. The method of claim 1 wherein the user interface has a rail, wherein the rail identifies the open separators during the obtaining of an image and inputting steps.

11. The method of claim 1 comprising the additional step of:
e) verifying the accuracy of a document scan job by comparing the physical documents with the electronic document image tree.

12. The method of claim 1 comprising the additional step of:
e) displaying the image of selected pages of the physical document.

13. A system for capturing an accurate representation of a document in a computer memory, said system comprising:
a scanner for obtaining into a computer memory an image of multiple physical pages of documents; and
a touch-screen monitor for obtaining marker information identifying the beginning and ending page locations of one or more documents and the type of separator at the beginning and ending page locations, said monitor having a touchable location to initiate the scanner obtaining an image, said monitor having a touchable location to open one or more separators, and said monitor having a touchable location to close a separator.

14. The system of claim 13 wherein the touch-screen monitor has a touchable location for closing all open separators.

15. The system of claim 13 wherein the touchable locations to initiate the scanner, open a separator and close a separator are on a single screen.

16. The system of claim 13 wherein the touch-screen monitor has a single touchable location to both scan the page and obtain a marker information.

17. The system of claim 13 wherein the touch-screen monitor further comprises a touchable location, which when activated, displays scanned pages and marker information.

18. The system of claim 13 wherein the touch-screen monitor further comprises a location to identify whether the page to be scanned is simplex or duplex.

19. A method for managing a document capture workflow using a single computer application comprising:
a) obtaining job information for at least one document capture job, including information sufficient to identify the document capture job;
b) capturing the documents in the document capture job including images for the pages of the documents and information about how the documents are separated; and
c) processing the document capture job so a user can view the documents in a desirable format.

20. The method of claim 19 comprising the further step of:
sectioning the job into multiple subjobs.

21. The method of claim 20 comprising the further step of:
identifying the employee designated to perform at least the capture step on a particular sub-job.

22. The method of claim 21 comprising the further step of:
monitoring the progress of each sub-jobs.

23. The method of claim 19 comprising the further step of:
comparing the captured documents with the physical documents to reduce reproduction errors and separator errors.

24. The method of claim 20 comprising the further step of:
analyzing employee productivity using information from the capturing documents step and the comparing documents step.

25. The method of claim 19 wherein the processing the job step comprises endorsing the captured documents.

26. The method of claim 19 wherein the processing the job step comprises printing the captured documents.

27. The method of claim 19 wherein the processing the job step comprises performing optical character recognition on the captured documents.

28. The method of claim 19 wherein the processing the job step comprises exporting the captured documents in a desirable electronic format.

29. The method of claim 19 wherein the processing the job step comprises renumbering the captured documents.
